(19) United States
(12) Patent Application Publication
(10) Pub. No.: US 2015/0063417 A1
(43) Pub. Date: Mar. 5, 2015

(54) TEMPERATURE SENSING CIRCUIT FOR IGBT MODULE

(71) Applicant: Hyundai Motor Company, Seoul (KR)

(72) Inventors: Jee Hye Jeong, Hwaseong (KR); Ki Jong Lee, Osan (KR); Kang Ho Jeong, Hwaseong (KR)

(73) Assignee: HYUNDAI MOTOR COMPANY, Seoul (KR)

(21) Appl. No.: 14/107,815

(22) Filed: Dec. 16, 2013

(30) Foreign Application Priority Data
Aug. 30, 2013 (KR) 10-2013-0104103

(51) Int. Cl. G01K 7/22; G01K 13/00

(52) U.S. Cl. CPC G01K 7/22; G01K 13/00
USPC 374/152

(57) ABSTRACT

A temperature sensing circuit for an insulated gate bipolar transistor (IGBT) module, which enables a temperature of the IGBT module to be sensed by a pulse width modulation (PWM) method, using a photo coupler, etc., is provided. In the temperature sensing circuit for the IGBT module, a voltage value between both terminals of a diode is measured, the measured voltage value is converted into a digital signal, using a pulse width modulation (PWM) technique, and the converted digital signal is easily transmitted to a controller such as a microcomputer (MICOM), using a photo coupler for electrical insulation, so that it is possible to analyze the duty of the digital signal, thereby sensing an accurate temperature.

### CROSS-REFERENCE TO RELATED APPLICATION

This application claims under 35 U.S.C. §119(a) the benefit of Korean Patent Application No. 10-2013-0104103 filed Aug. 30, 2013, the en contents which are incorporated herein by reference.

### BACKGROUND

(a) Technical Field

The present invention relates to a temperature sensing circuit for an insulated gate bipolar transistor (IGBT) module. More particularly, the present invention relates to a temperature sensing circuit for an IGBT module, which enables a temperature of the IGBT module to be sensed by a pulse width modulation (PWM) method, using a photo coupler, etc.

(b) Background Art

Recently, motor systems have started to be used in green vehicles because they exhaust no waste gas. These green vehicles include electric vehicles (EV), hybrid electric vehicles (HEV) or fuel cell electric vehicles (FCEV). In general, these motor systems include a driving motor for driving the vehicle, an inverter for converting a DC voltage from a main battery into an AC voltage and controlling the motor, and the like.

The inverter for driving the motor converts the DC voltage from the main battery into the AC voltage by switching the DC voltage, using a switching element, and boosts the voltage, using a transformer or the like in order to operate the motor. An insulated gate bipolar transistor (IGBT) which can perform a high-speed switching operation even in higher power outputs is frequently used as the switching element in the inverter. Since the capacity of current transferred or cut off through a switching operation of the IGBT module is larger than other modules, the IGBT module may become damaged by excessive temperatures and overcurrent.

Accordingly, a separate temperature sensor as a measuring means for logic, which can prevent the damage of the IGBT module from excessive temperature and the overcurrent, is often mounted in the IGBT module. The temperature sensor is frequently disposed on a direct bonded copper (DBC) of the IGBT module.

In this case, the temperature sensor uses a negative temperature coefficient (NTC) thermistor of which electrical resistance is consecutively changed depending on a temperature coefficient. Since the resistance of the NTC thermistor changes depending on the detected temperature, temperature sensing is possible using the NTC thermistor. For example, the temperature may be estimated using a voltage divided between the temperature sensor and another resistor.

However, the NTC thermistor non-linearly senses the temperature of the IGBT module. Therefore, the resolution is reduced at higher-temperatures, and hence it is difficult to accurately detect the temperature.

Particularly, the temperature of the DBC having the temperature sensor mounted thereon is somewhat like a cooler (i.e., a kind of heat sink having a coolant circulation path therein) in contact with a bottom surface of the DBC, and therefore, the temperature sensor does not accurately measure the junction temperature of a semiconductor chip as a component mounted in the IGBT module to generate heat in the exchanging operation of an electrical signal.

That is, although the temperature should account for the junction temperature of the semiconductor chip which generates heat, the temperature sensor may in some instances be affected by the temperature of a coolant in the cooler in contact with the DBC. As a result, the junction temperature of the semiconductor chip is not accurately. Therefore, the junction temperature of the semiconductor should be calculated separately to protect the junction temperature of the semiconductor chip. However, when this is done, a significant calculation error may occur in the calculation.

As such, when the junction temperature of the semiconductor chip is calculated, a junction temperature estimation is estimated somewhat accurately through the estimation of heat model and calorific value during ordinary operation (e.g., motor operation at a frequency of 50 Hz or more) of the inverter. However, it is difficult to estimate the junction temperature of the semiconductor chip in a hill hold mode. In addition, an error occurring for each sample frequency during variable switching the inverter for controlling the motor is considerably increased. As a result, the excess temperature of the IGBT module including the semiconductor chip is not effectively protected.

Hill hold mode refers to a mode in which the green vehicle is prevented from rolling backward on a slope by controlling the torque of the driving motor, using the inverter. When a current sensor is broken, the temperature substituted in the logic for protecting the excessive temperature and the overcurrent is erroneously estimated, and therefore, the IGBT module is not effectively protected from the excessive temperatures. As a result, the IGBT module is damaged during the operation of the green vehicle. Therefore, the operation of the vehicle is terminated, and accordingly, effecting the driver's safety.

As a conventional plan for solving such a problem, a technique has been considered in which a temperature sensor is not placed on a DBC board but is instead built into a semiconductor chip. That is, a diode is built into an IGBT module to directly sense a temperature of the IGBT module. However, this technique is disadvantageous in that electrical insulation is required between the low-voltage diode and the high-voltage IGBT module for safety reasons. The electrical insulation may be provided through a digital element such as a photo coupler. However, it is difficult to transmit an analog temperature value to an insulated digital element.

### SUMMARY OF THE DISCLOSURE

The present invention provides a temperature sensing circuit for an insulated gate bipolar transistor (IGBT) module, in which a voltage value between both terminals of a diode is measured, the measured voltage value is converted into a digital signal, using a pulse width modulation (PWM) technique, and the converted digital signal is transmitted to a controller such as a microcomputer (MICOM), using a photo coupler as electrical insulation, so that it is possible to analyze the duty of the digital signal, thereby sensing an accurate temperature.

In one aspect, the present invention provides a temperature sensing circuit of an IGBT module, including a temperature sensing circuit module built in the IGBT module, wherein the temperature sensing circuit module includes: one or more diodes integrated in the IGBT module; an encoder that measures a voltage value between both terminals of the diode when current flows through the diode, and converts the measured analog voltage value into a digital signal; and a decoder connected to be insulated from the encoder, the decoder measuring the voltage value between both the terminals of the diode based on the digital signal from the encoder. Also included is a photo coupler that is connected between an output terminal of the encoder and the input terminal of the decoder to enable a signal to be transmitted in an insulated state therebetween; and a MICOM for changing, into a temperature, the voltage value between both the terminals of the diode, provided by the decoder.

In an exemplary embodiment, the diode and the encoder may be integrated into the IGBT module acting as a high-voltage component, and the decoder and the MICOM acting as low-voltage components may be integrated on the outside of the IGBT module.

In another exemplary embodiment, when several temperature sensing circuit modules exist, decoders of the temperature sensing circuit modules may be simultaneously connected to the MICOM with one wire, using a wired-OR technique.

In still another exemplary embodiment, a first amplifier may be connected between the output terminal of the encoder and an input terminal of the photo coupler, a second amplifier may be connected between an output terminal of the photo coupler and the input terminal of the decoder, and a third amplifier may be connected between an outer terminal of the decoder and an input terminal of the MICOM.

Other aspects and exemplary embodiments of the invention are discussed infra.

Advantageously, according to the present invention, a voltage value between both terminals of a diode is measured. The measured voltage value is converted into a digital signal, using a PWM technique, and the converted digital signal is then transmitted to a controller such as a MICOM, using a photo coupler for electrical insulation, so that it is possible to analyze the duty of the digital signal, thereby sensing an accurate temperature.

Particularly, the diode integrated in the IGBT module, a high-voltage component, and the MICOM, e.g., a low-voltage component, are connected through the photo coupler in order to be insulated from each other, so that it is possible to easily use the maximum output of the IGBT module and to protect the low-voltage MICOM.

Further, several temperature sensing circuit modules including encoders and decoders as well as diodes are connected to one MICOM, using the wired-OR technique, so that it is possible to transmit temperature sensing signals of a plurality of IGBT modules to the MICOM in a series connection scheme. Accordingly, it is possible to decrease the number of output lines and connector pins.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a circuit diagram showing an embodiment of a temperature sensing circuit for an insulated gate bipolar transistor (IGBT) module according to an exemplary embodiment of the present invention;

FIG. 2 is a schematic diagram showing an example in which temperature sensing components of the IGBT module are connected to one microcomputer (MICOM) by a wired-OR technique according to the exemplary embodiment of the present invention; and

FIG. 3 is a waveform diagram showing a pulse width modulation (PWM) duty signal of the temperature sensing circuit for the IGBT module according to the exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar terms as used herein is inclusive of motor vehicles in general such as passenger automobiles including sports utility vehicles (SIN), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles, and other alternative fuel vehicles (e.g., fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Additionally, it is understood that the below methods are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

In the exemplary embodiment of the present invention, unlike conventional methods that use existing thermistors, a voltage value between both terminals of a diode integrated in an insulated gate bipolar transistor (IGBT) module is measured, the measured voltage value is converted into a digital signal, using a pulse width modulation (PWM) technique, and the converted digital signal is transmitted to a controller, such as a microcomputer (MICOM), using a photo coupler for electrical insulation. Accordingly, it is possible to analyze the duty of the digital signal, thereby sensing an accurate temperature.

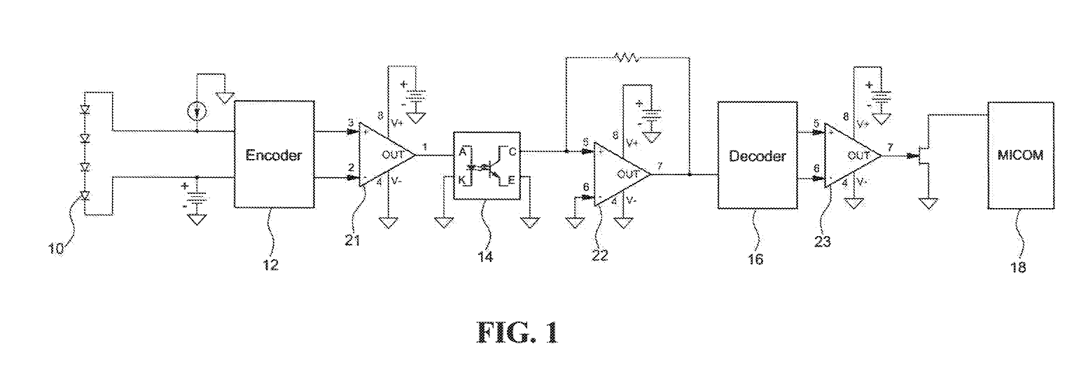

To this end, a temperature sensing circuit module of the present invention, as shown in the circuit diagram of FIG. 1, includes a diode 10, an encoder 12, a decoder 16, a MICOM 18 and the like. Particularly, the diode 10 and the encoder 12 are integrated within the IGBT module, embodied as a high-voltage component, and the decoder 16 and the MICOM 18, embodied as low-voltage components, are integrated on the outside of the IGBT module. More specifically, photo coupler 14, which allows a signal to be transmitted while in an insulation state, is disposed between the encoder 12 and the decoder 16.

In particular, the diode 10 has linear characteristics with respect to temperature. Hence, when a voltage difference between input and output terminals of the diode 10 is measured, the temperature is low as the measured voltage is large. On the contrary, the temperature is high as the measured voltage is small.

For example, it may be assumed that, when a current of about 0.01 A flows through the diode, the maximum voltage difference between both the terminals of the diode is about 800 mV at −25° C., and the minimum voltage difference between both the terminals of the diode is about 450 mV at 150° C.

In order to use the diode 10 having such a characteristic as a temperature sensing means of the IGBT module, the diode 10 is integrated at a heat generation portion (e.g., a portion close to a semiconductor chip, etc.) in the IGBT module, and current and voltage sources are respectively connected to input and output lines of the diode 10. In this case, the encoder 12 is connected directly to the input and output terminals of the diode 10. Hence, the encoder 12 measures a voltage difference between both the terminals of the diode 10 and converts the measured analog signal into a digital signal. Thus, if a constant current is applied to the diode 10, the encoder 12 measures a voltage value between both the terminals of the diode 10 according to temperature.

Particularly, the encoder 12 measures a voltage difference between the input and output terminals of the diode 10, converts the measured analog signal (voltage value) into a digital signal, and then outputs the converted digital signal accordingly. In this case, the encoder 12 outputs the converted digital signal, using a PWM technique.

When the analog signal (e.g., a voltage value) is converted into the digital signal, using the PWM technique as described above, the duty of the digital signal is set, so that it is possible to estimate a temperature of the IGBT module.

For example, as can be seen in FIG. 3, the encoder 12 may set the PWM duty value of the digital signal to about 25% based on the voltage difference between both the terminals of the diode, and may set the PWM duty value of the digital signal to 75%. Thus, the encoder 12 outputs the PWM duty value in a range of about 25% to 75% according to the voltage difference.

Meanwhile, the diode 10 and the encoder 12 are components which directly measure a temperature of the IGBT module and digitalize the measured temperature. Therefore, the diode 10 and the encoder 12 are integrated within the IGBT module which is acting as the high-voltage component. On the other hand, the decoder 16 and the MICOM 18, which analyze the temperature of the IGBT module, based on the digital signal of the encoder 12, are low-voltage components operated at is low voltage. Thus, an output terminal of the encoder 12 and an input terminal of the decoder 16 are connected electrically adjacent to the photo coupler 14 which enables a signal to be transmitted in a mutual insulation state.

In this case, first and second amplifiers 21 and 22 providing signal amplification are respectively connected between the output terminal of the encoder 12 and an input terminal of the photo coupler 14 and between an output terminal of the photo coupler 14 and the input terminal of the decoder 16. Thus, the digital signal (PWM duty value) output from the encoder 12 is primarily amplified through the first amplifier 21 and then transmitted to the decoder 16 through the photo coupler 14. The digital signal passes through the photo coupler 14 before being transmitted to the decoder 16 and is secondarily amplified by the second amplifier 22.

The decoder 16 is connected electrically adjacent to the encoder be insulated by the photo coupler 14. Thus, the decoder 16 measures a voltage difference between both the terminals of the diode, based on the digital signal from the encoder 12, and then transmits the measured value to the MICOM 18. In this case, the signal of the measured value from the decoder 16 is amplified through a third amplifier 23 and then transmitted to the MICOM 18.

Finally, the MICOM 18 analyzes the measured value provided from the decoder 16 and changes the measured value into the temperature of the IGBT. For example, when the voltage difference between both the terminals of the diode is about 800 mV, the MICOM 18 translates 800 mV into −2° C. When the voltage difference between both the terminals of the diode is 450 mV, the MICOM 18 translates 450 mV into 150° C.

Meanwhile, when several temperature sensing circuit modules exist, i.e., when several temperature sensing circuit modules are integrated to sense temperatures of other heat generation elements and components including the IGBT module, the temperature sensing modules may be connected to one MICOM, using a wired-OR technique.

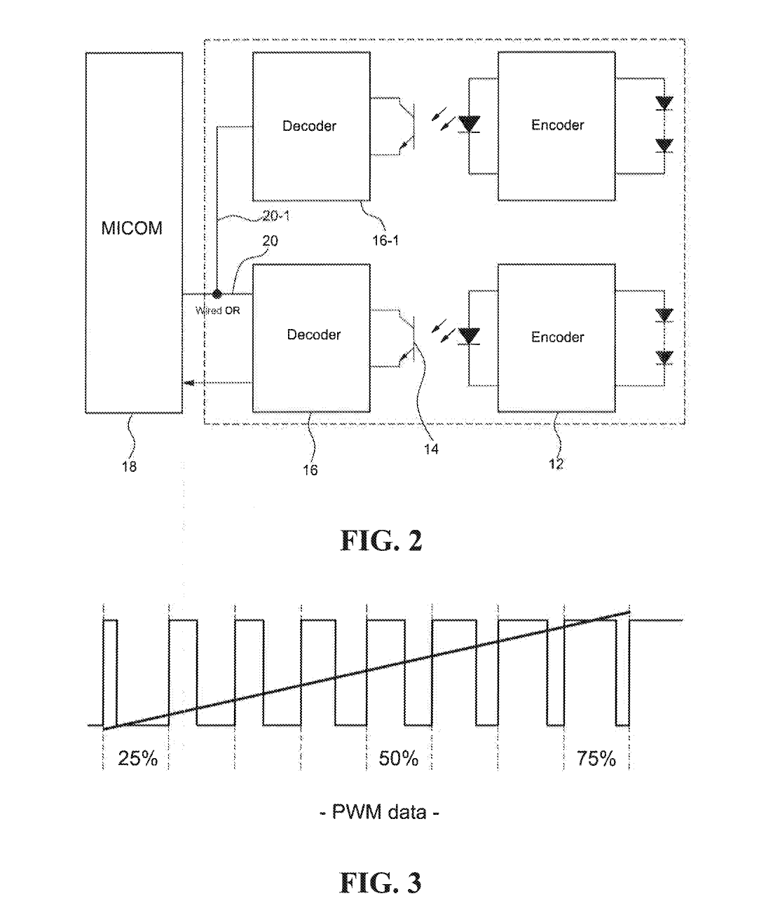

The wired-OR technique refers a technique in which, as can be seen in FIG. 2, an output line 20 of one temperature sensing circuit module selected from a plurality of temperature sensing circuit modules is connected to the MICOM 18, and output lines 20-1, . . . , 20-n of decoders 16-1, . . . , 16-n of the other temperature sensing circuit modules are connected electrically adjacent to the output line 20 connected to the MICOM 18.

As described above, several temperature sensing circuit modules including encoders and decoders as well as diodes are connected to one MICOM, using the wired-OR technique, so that it is possible to transmit temperature sensing signals of a plurality of IGBT modules to the MICOM in a series communication or connection scheme. Accordingly, it is possible to decrease the number of output lines and connector pins.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A temperature sensing circuit of an insulated gate bipolar transistor (IGBT) module, comprising a temperature sensing circuit module built in the IGBT module,
wherein the temperature sensing circuit module includes:
one or more diodes integrated within the IGBT module;
an encoder that measures a voltage value between both terminals of the diode when current flows through the diode, and converts the measured analog voltage value into a digital signal;
a decoder connected to be insulated from the encoder, to measure the voltage value between both the terminals of the diode, based on the digital signal from the encoder;
a photo coupler connected between an output terminal of the encoder and the input terminal of the decoder to enable a signal to be transmitted while in an insulation state therebetween; and
a microcomputer (MICOM) translating, into a temperature, the voltage value between both the terminals of the diode, provided by the decoder.

2. The temperature sensing circuit of claim 1, wherein the diode and the encoder are integrated within the IGBT module, and the decoder and the MICOM are integrated on the outside of the IGBT module.

3. The temperature sensing circuit of claim 1, wherein, when a plurality of temperature sensing circuit modules exist, decoders of the temperature sensing circuit modules are simultaneously connected to the MICOM with one wire, using a wired-OR technique.

4. The temperature sensing circuit of claim 1, wherein a first amplifier is connected between the output terminal of the encoder and an input terminal of the photo coupler, a second amplifier is connected between an output terminal of the photo coupler and the input terminal of the decoder, and a third amplifier is connected between an outer terminal of the decoder and an input terminal of the MICOM.

5. A temperature sensing circuit module comprising:
one or more diodes integrated within an IGBT module;
an encoder connected between both terminals of the diode to measure current flows through the diode to measure an analog voltage value, and convert a measured analog voltage value into a digital signal;
a decoder insulated electrically from the encoder, configured to measure the voltage value between both the terminals of the diode, based on the digital signal from the encoder;
a photo coupler connected between an output terminal of the encoder and the input terminal of the decoder; and
a microcomputer (MICOM) translating, into a temperature, the voltage value between both the terminals of the diode, provided by the decoder.

6. The temperature sensing circuit module of claim 5, wherein the diode and the encoder are integrated within the IGBT module, and the decoder and the MICOM are integrated on the outside of the IGBT module.

7. The temperature sensing circuit module of claim 5, wherein, when a plurality of temperature sensing circuit modules exist, decoders of the temperature sensing circuit modules are simultaneously connected to the MICOM with one wire, using a wired-OR technique.

8. The temperature sensing circuit module of claim 5, wherein a first amplifier is connected between the output terminal of the encoder and an input terminal of the photo coupler, a second amplifier is connected between an output terminal of the photo coupler and the input terminal of the decoder, and a third amplifier is connected between an outer terminal of the decoder and an input terminal of the MICOM.
